(19) United States
(12) Patent Application Publication
(10) Pub. No.: US 2014/0071282 A1
(43) Pub. Date: Mar. 13, 2014

(54) ALERT SYSTEMS AND METHODS USING REAL-TIME LANE INFORMATION

(71) Applicants: MOHANNAD MURAD, TROY, MI (US); PAUL R. WILLIAMS, NORTHVILLE, MI (US)

(72) Inventors: MOHANNAD MURAD, TROY, MI (US); PAUL R. WILLIAMS, NORTHVILLE, MI (US)

(73) Assignee: GM GLOBAL TECHNOLOGY OPERATIONS LLC, DETROIT, MI (US)

(21) Appl. No.: 13/614,713

(22) Filed: Sep. 13, 2012

(51) Int. Cl. B60Q 1/00; H04N 7/18

(52) U.S. Cl. 348/148; 348/E07.085

(57) ABSTRACT

Methods and systems are provided for alerting a driver of a vehicle. In one embodiment, a method includes: receiving sensor data that is generated by an image sensor that senses conditions in proximity of the vehicle; determining real-time lane information from the sensor data, wherein the real-time lane information includes at least one of a lane width, a lane type, and a lane curvature; selectively performing an alert method that evaluates the presence of objects in proximity to the vehicle based on the real-time lane information; and selectively generating an alert signal to alert the driver based on the alert method.

### TECHNICAL FIELD

The technical field generally relates to alert systems of a vehicle, and more particularly relates to alert systems of a vehicle that utilize real-time lane information for alerting a driver of the vehicle

### BACKGROUND

Vehicles include alert systems that detect objects in proximity to the vehicle and alert the driver to the object. The alerts are typically generated based on a location of the object and based on a particular driving maneuver that is or will be occurring. Such alert systems can include, but are not limited to, side blind zone alert systems, lane change alert systems, and other systems using front, side, and rear view cameras.

Sensory devices coupled to the rear, side, and/or front of the vehicle detect objects within particular areas. Typically the sensory devices are placed and/or calibrated to detect objects within a defined area around the vehicle. For example, the defined area may be intended to encompass an adjacent lane. However, the width of the lane can vary from road to road, and thus the predefined area may encompass more or less than the adjacent lane. When the predefined area encompasses an area that includes more than the adjacent lane, moving objects that fall within that area but that fall outside of the adjacent lane may be detected (e.g., a moving vehicle may be detected two lanes over). Such objects would be interpreted by the sensory device as being within the adjacent lane and, consequently, may cause false alerts.

Accordingly, it is desirable to provide methods and systems that take into account real-time lane information when generating the alerts. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for alerting a driver of a vehicle. In one embodiment, a method includes: receiving sensor data that is generated by an image sensor that senses conditions in proximity of the vehicle; determining real-time lane information from the sensor data, wherein the real-time lane information includes at least one of a lane width, a lane type, and a lane curvature; selectively performing an alert method that evaluates the presence of objects in proximity to the vehicle based on the real-time lane information; and selectively generating an alert signal to alert the driver based on the alert method.

In another embodiment, a system includes a first module that receives sensor data that is generated by an image sensor of the vehicle, and that determines real-time lane information from the sensor data, wherein the real-time lane information includes at least one of a lane width, a lane type, and a lane curvature. A second module selectively performs an alert method that evaluates the presence of objects in proximity to the vehicle based on the real-time lane information and selectively generates an alert signal to alert the driver based on the alert method.

In still another embodiment, a vehicle includes at least one image sensor that generates a sensor signal. A control module receives the sensor signal, determines real-time lane information from the sensor signal, performs an alert method that evaluates the presence of objects in proximity to the vehicle based on the real-time lane information, and selectively generates an alert signal to alert the driver based on the alert method. The real-time lane information includes at least one of a lane width, a lane type, and a lane curvature.

### DESCRIPTION OF THE DRAWINGS

The exemplary embodiments will hereinafter be described in conjunction with the following drawing figures, wherein like numerals denote like elements, and wherein:

FIG. 1 is illustration of a vehicle that includes an alert system in accordance with various embodiments;

FIG. 2 is a dataflow diagram illustrating an alert control system of the alert system in accordance with various embodiments;

FIGS. 3 and 4 are illustrations of the vehicle according to different driving scenarios along multiple lane roads; and

FIG. 5 is a flowchart illustrating an alert method that may be performed by the alert system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

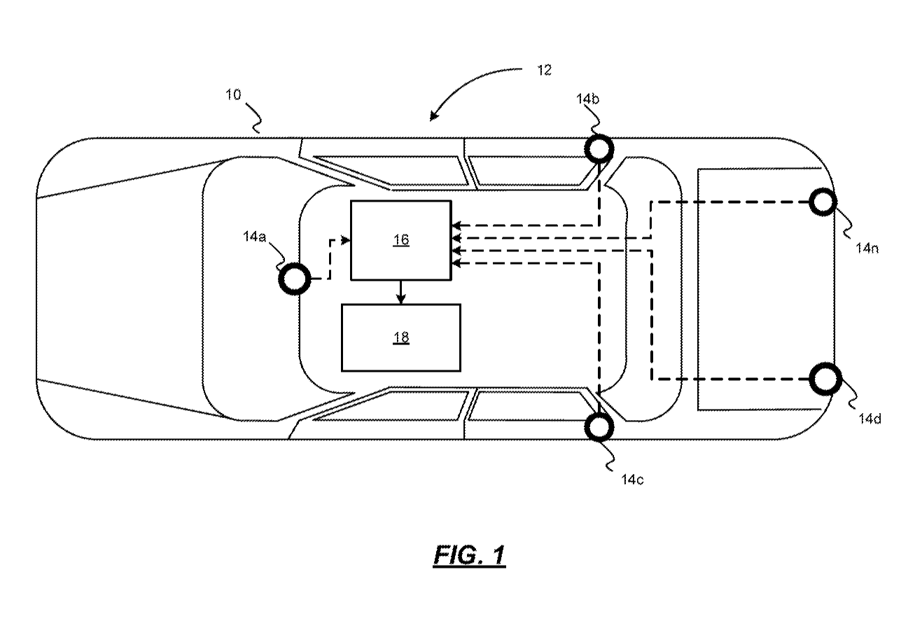

Referring now to FIG. 1, a vehicle 10 is shown to include a vehicle alert system 12. Although the figures shown herein depict an example with certain arrangements of elements, additional intervening elements, devices, features, or components may be present in an actual embodiments. It should also be understood that FIG. 1 is merely illustrative and may not be drawn to scale.

The vehicle alert system 12 includes one or more sensors 14a-14n that sense observable conditions in proximity to the vehicle 10. The sensors 14a-14n can be image sensors, radar sensors, ultrasound sensors, or other sensors that sense observable conditions in proximity to the vehicle 10. For exemplary purposes, the disclosure is discussed in the context of the sensors 14a-14n being image sensors or cameras that track visual images of the surroundings of the vehicle 10. The image sensors can include, but are not limited to, a front image sensor 14a, a right side image sensor 14b, a left side image sensor 14c, and rear image sensors 14d, 14n.

The sensors 14a-14n sense the surroundings of the vehicle 10 and generate sensor signals based thereon. A control module 16 receives the signals, processes the signals, and selectively generates an alert signal. A warning system 18 receives the alert signal and generates an audible or visual warning to warn a driver or other occupant of the vehicle of an object in proximity to the vehicle 10. In various embodiments, the control module 16 determines real-time lane information based on the sensor signals and uses the real-time lane information in one or more alert methods to selectively generate the alert signals.

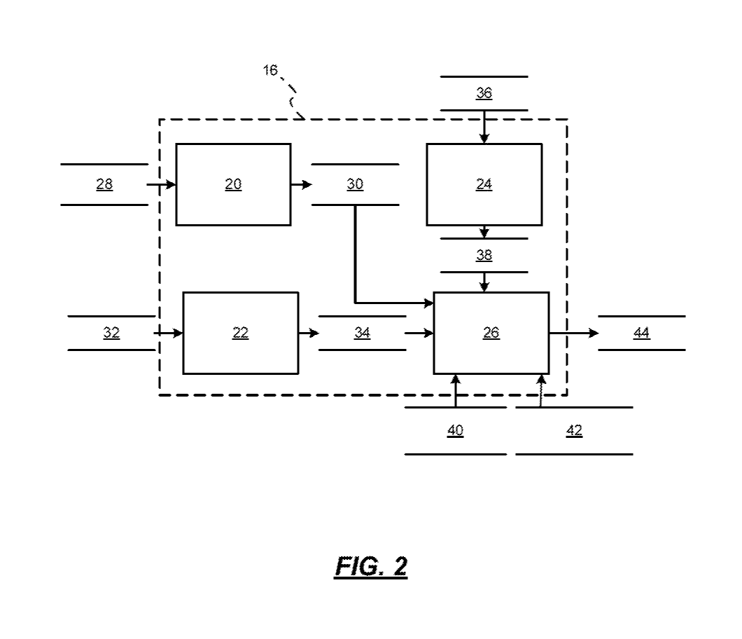

Referring now to FIG. 2, a dataflow diagram illustrates various embodiments of the control module 16 of the alert system 12 (FIG. 1). Various embodiments of the control module 16 according to the present disclosure may include any number of sub-modules. As can be appreciated, the sub-modules shown in FIG. 2 may be combined and/or further partitioned to similarly alert the driver based on real-time lane information. Inputs to the control module 16 may be received from the sensors 14a-14n (FIG. 1) of the vehicle 10 (FIG. 1), received from other control modules (not shown) of the vehicle 10 (FIG. 1), and/or determined by other sub-modules (not shown) of the control module 16. In various embodiments, the control module 16 includes a lane width determination module 20, a lane type determination module 22, a lane curvature determination module 24, an object detection module 26, and an alert module 27.

The lane width determination module 20 receives as input sensor data 28 from the front image sensor 14a and/or rear image sensors 14d, 14n of the vehicle 10 (FIG. 1). Based on the sensor data 28, the lane width determination module 20 determines a lane width 30 of the current lane or an adjacent lane. The lane width determination module 20 determines the lane width 30 by determining a distance between the markers of the current lane or an adjacent lane. For example, the lane width determination module 20 determines a distance from a first marker detected from the sensor data 28 to be to the left of the vehicle 10 to a second marker detected from the sensor data 28 to be the right of the vehicle 10. The lane width 30 is set equal to the distance; and an adjacent lane width is assumed to be equal to the lane width 30. In another example, the lane width determination module 20 determines the lane width 30 for an adjacent lane by determining a distance from a first marker detected from the sensor data 28 to be to the side (left or right) of the vehicle 10 to a second marker detected from the sensor data 28 to be the next marker beyond and further to the side (left or right) of the vehicle 10.

The lane type determination module 22 receives as input sensor data 32 from the front image sensor 14a, the side image sensors 14b, 14c, and/or the rear image sensors 14d, 14n of the vehicle 10. Based on the sensor data 32, the lane type determination module 22 determines a lane type 34 of the current lane. The lane type 34 may be, for example, but is not limited to, a right side single lane (e.g., a lane that is a single lane in the current direction and is the only lane to the right), a middle lane (e.g., a lane that has lanes on both sides in the same direction), a left side single lane (e.g., a lane that is a single lane in the current direction and is the only lane to the left), a right side multiple lane (e.g., a lane that is a rightmost lane of multiple lanes in the same direction), and a left side multiple lane (e.g. a lane that is a leftmost lane of multiple lanes in the same direction). In various embodiments, the lane type determination module 22 determines the lane type based on the detected lane markers (e.g., whether they be solid lines or dashed lines, whether they be white or yellow, etc.) to the right of the vehicle 10 and to the left of the vehicle 10.

The lane curvature determination module 24 receives as input sensor data 36 from any one of the front image sensor 14a, the side image sensors 14b, 14c, and the rear image sensors 14d, 14n of the vehicle 10. Based on the sensor data 36, the lane curvature determination module 24, determines a curvature 38 of the lane. For example, the lane curvature determination module 24 evaluates the sensor data 36 of the front image sensor 14a and depending on the patterns of how lane markings are appearing in the image, lane projected paths and lane curvature calculations are performed.

The alert module 26 receives as input the lane width 30, the lane type 34, the lane curvature 38, object data 40, and vehicle maneuver data 42. The object data 40 represents the presence of an object that has been detected (e.g., by radar or other sensing device) in proximity to the vehicle 10. Based on the inputs, the alert module 26 performs one or more alert methods. The alert methods selectively generate alert signals 44 to alert the driver of the detected object based on the lane width 30, the lane type 34, and the lane curvature 38 that are determined real-time.

In various embodiments, the alert methods can include, but are not limited to, side blind zone alert methods, and lane change alert methods. The side blind zone alert methods, for example, evaluate a threat of making a safe lane change maneuver based on detecting vehicles in a blind zone in the adjacent lane, next to the vehicle. The lane change alert methods, for example, evaluate a threat of making a safe lane change maneuver based on computing a delta speed of approaching objects (e.g., vehicles) in adjacent lanes.

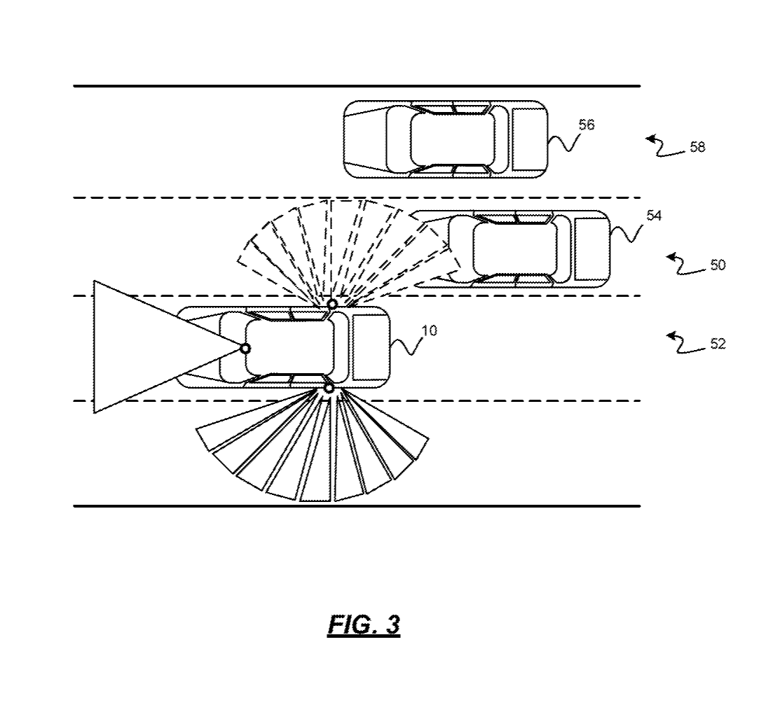

For example, as shown in FIG. 3, the lane change alert methods take into account the lane width 30 of lane 50 adjacent to a current lane 52 (e.g., which is assumed to be the same as the lane width 30 of the current lane 52, or which can be computed, for example, using the side image sensors 14b or 14c) when determining whether an object 54 within the adjacent lane 50 is a threat. This prevents the lane change alert method from detecting an object 56 in lane 58 as a threat which is two lanes over (e.g., due to an incorrect lane width) and generating false alerts.

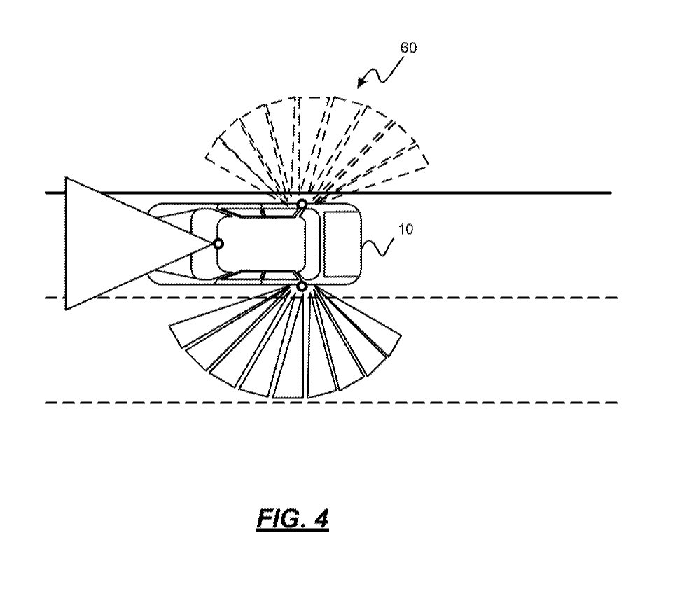

In another example, as shown in FIG. 4, the side blind zone alert method takes into account the lane type 34 when determining whether to evaluate the sensor data 40. For example, in FIG. 4, the lane type 34 is rightmost multiple lane. The evaluation of the sensor data 60 can be turned off on the right side and thus, the alerts turned off when the current lane type is the rightmost lane and there are no other lanes to the right.

As can be appreciated, in accordance with various embodiments, other alert methods known in the art can take into account this real-time information to improve the integrity of the alert method and to reduce the number of false alerts.

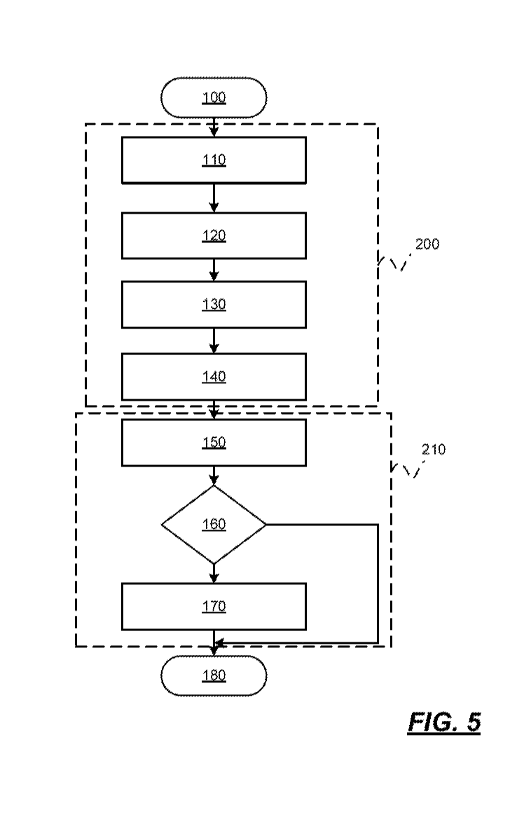

Referring now to FIG. 5, and with continued reference to FIGS. 1 and 2, a flowchart illustrates an alert method that can be performed by the alert systems of FIGS. 1 and 2 in accordance with various embodiments. As can be appreciated in light of the disclosure, the order of operation within the method is not limited to the sequential execution as illustrated in FIG. 5, but may be performed in one or more varying orders as applicable and in accordance with the present disclosure.

As can further be appreciated, the method of FIG. 5 may be scheduled to run at predetermined time intervals during operation of the vehicle and/or may be scheduled to run based on predetermined events.

In one example, the method may begin at 100. The sensor data is received at 110. The real-time lane information is determined at 200. In particular, the current lane width is determined, for example, as discussed above, at 120. The lane type is determined, for example, as discussed above at 130. The lane curvature is determined, for example, as discussed above at 140.

Once the real-time lane information is determined at 200, the alert methods are performed at 210 based on the real-time lane information. In particular, one or more of the alert methods selectively evaluate one or more of the lane width, the lane type, and the lane curvature to determine whether an alert should be generated at 150. If it is determined that a condition exists in which an alert should be generated at 160, the alert signal is generated at 170. Thereafter, the method may end at 180. If it is determined that a condition does not exist in which the alert should be generated at 160, the method may end at 180.

As can be appreciated, although the steps 200 and 210 are shown to be performed in sequential order, in various embodiments, the real-time information determination steps of 200 can be performed at different time intervals than time intervals of the alert method steps of 210. In further various embodiments, various alert methods can be further performed at different time intervals from each other.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A method of alerting a driver of a vehicle, the method comprising:
receiving sensor data that is generated by an image sensor that senses conditions in proximity of the vehicle;
determining real-time lane information from the sensor data, wherein the real-time lane information includes at least one of a lane width, a lane type, and a lane curvature;
selectively performing an alert method that evaluates the presence of objects in proximity to the vehicle based on the real-time lane information; and
selectively generating an alert signal to alert the driver based on the alert method.

2. The method of claim 1 wherein the selectively generating the alert signal is based on a lane change alert method that evaluates the real-time lane information.

3. The method of claim 2 further comprising performing the lane change alert method based on the lane type.

4. The method of claim 2 further comprising performing the lane change alert method based on the lane width.

5. The method of claim 2 further comprising performing the lane change alert method based on the lane curvature.

6. The method of claim 1 wherein the selectively generating the alert signal is based on a side blind zone alert method that evaluates the real-time lane information.

7. The method of claim 6 further comprising performing the side blind zone alert method based on the lane type.

8. The method of claim 6 further comprising performing the side blind zone alert method based on the lane width.

9. The method of claim 6 further comprising performing the side blind zone alert method based on the lane curvature.

10. The method of claim 1 wherein the determining the real-time lane information comprises determining the lane type, the lane width and the lane curvature.

11. A system for alerting a driver of a vehicle, the system comprising:
a first module that receives sensor data that is generated by an image sensor of the vehicle, and that determines real-time lane information from the sensor data, wherein the real-time lane information includes at least one of a lane width, a lane type, and a lane curvature; and
a second module that selectively performs an alert method that evaluates the presence of objects in proximity to the vehicle based on the real-time lane information and that selectively generates an alert signal to alert the driver based on the alert method.

12. The system of claim 11 wherein the second module selectively generates the alert signal based on a lane change alert method that evaluates the real-time lane information.

13. The system of claim 12 wherein the second module performs the lane change alert method based on the lane type.

14. The system of claim 12 wherein the second module performs the lane change alert method based on the lane width.

15. The system of claim 12 wherein the second module performs the lane change alert method based on the lane curvature.

16. The system of claim 11 wherein the second module selectively generates the alert signal based on a side blind zone alert method that evaluates the real-time lane information.

17. The system of claim 16 wherein the second module performs the side blind zone alert method based on the lane type.

18. The system of claim 16 wherein the second module performs the side blind zone alert method based on the lane width.

19. The system of claim 16 wherein the second module performs the side blind zone alert method based on the lane curvature.

20. A vehicle, comprising:
at least one image sensor that generates a sensor signal; and
a control module that receives the sensor signal, that determines real-time lane information from the sensor signal, that performs an alert method that evaluates the presence of objects in proximity to the vehicle based on the real-time lane information, and that selectively generates an alert signal to alert a driver based on the alert method, wherein the real-time lane information includes at least one of a lane width, a lane type, and a lane curvature.
